(19) United States
(12) Patent Application Publication
(10) Pub. No.: US 2019/0215937 A1
(43) Pub. Date: Jul. 11, 2019

(54) REPLACEABLE LIGHT EMISSION MODULE FOR TRANSMITTING WIRELESS SIGNAL,NAVIGATION SYSTEM USING LIGHT EMISSION MODULE, AND NAVIGATION METHOD THEREOF

(71) Applicant: PLS Opto-Electronic Co., Ltd., Taipei (TW)

(72) Inventors: Shao-Wei Chiu, Taipei (TW); Yin Cheng Huang, Taipei (TW)

(73) Assignee: PLS Opto-Electronic Co., Ltd., Taipei (TW)

(21) Appl. No.: 16/241,933

(22) Filed: Jan. 7, 2019

(30) Foreign Application Priority Data
Jan. 8, 2018 (TW) 107100657

(51) Int. Cl. H05B 37/02; H05B 33/08; H04W 88/02; H04W 4/029

(52) U.S. Cl. CPC H05B 37/0272; H04W 4/029; H04W 88/02; H05B 33/0845

(57) ABSTRACT

The prevent invention provides a navigation method, used in a navigation system. The navigation system includes a server device, a mobile electronic device, and a plurality of light emitting modules detachably secured in a plurality of lamp-holders. The navigation method includes the following steps: the plurality of light emitting modules continuously transmitting a wireless signal with identification information; the mobile electronic device receiving the identification information and respectively determining a distances between the mobile electronic device and the light emitting modules transmitting the identification information, and storing the distances as distance information; the electronic device determining a position of the mobile electronic device based on the identification information, the distance information, the map information and flag information stored in the server device.

### CROSS REFERENCE

The present invention claims priority to TW 107100657, filed on Jan. 8, 2018.

### BACKGROUND OF THE INVENTION

### Field of Invention

The present invention relates to a navigation system and a navigation method thereof, especially a navigation system and navigation method using a replaceable light emitting module for transmitting a wireless signal.

### Description of Related Art

With rapid progress in wireless communication technology, many new applications based on the wireless technology and services appear. In the wireless technology, an advanced development of various mobile electronic devices, such as positioning and navigation functions, which are increasingly improved and powerful. The well-known Global Positioning System (GPS) is one example. This GPS technology has positioning function obtained by triangulation calculation based on wireless signals from satellites.

However, the positioning function of GPS technology, needs to keep the mobile electronic device to receive wireless signals from the satellites. Therefore, when there is excessive shielding covering the satellite signal from the mobile electronic device, the GPS positioning capability will be severely affected. Since the wireless GPS positioning signals are transmitted from the satellites, which are very far away in the outer space. Any slight distance or angular deviation will obviously change the calculation result of the triangulation calculation. The calculation result may deviate from 1 to 5 meters, so it is not feasible for precise positioning. In short, GPS positioning is suitable for planar positioning, but not for floor height positioning in a multiple-floor building. That is, the existing GPS positioning technology is not suitable for indoor application.

In view of the above problems, some wireless technologies suitable for indoor positioning, such as infrared, ultrasonic, Bluetooth, or Zigbee wireless networks are provided. It is important to order to provide a more accurate and suitable indoor navigation. In these prior art technologies, the related equipments for this indoor navigation purpose are built on a large scale. This prior art has the disadvantages of high cost and too much labor time needed. In some public transportation junctions (such as airport or station), the impact on public traffic brought by the building or setting up process is an important issue.

### SUMMARY OF THE INVENTION

In view of the above, one purpose of the present invention, is to provide a navigation system and a navigation method, which use a replaceable light emitting module, for reducing the building and maintaining costs.

In view of the above, one technical solution provided by the present invention is a replaceable light emitting module for transmitting the wireless signal. The replaceable light emitting module includes a substrate, at least one light emitting unit, and a wireless signal unit. The light emitting unit is disposed on the substrate. The wireless signal unit, is disposed on the substrate, and configured to continuously transmit the wireless signal with identification information. The substrate is detachably secured in a lamp for providing power.

In view of the above, one technology provided by the present invention is a navigation system, used on a location field with a plurality of lamps. The navigation system includes a plurality of replaceable light emitting modules, a server device, and a mobile electronic device. The replaceable light emitting modules, respectively disposed in the lamps on the location field. Each of the replaceable light emitting module includes a substrate, at least one light emitting unit, and a wireless signal unit. The substrate is detachably secured in the lamp. The light emitting unit is disposed on the substrate. The wireless signal unit is configured to continuously transmit the wireless signal with identification information. The server device stores map information and flag information. The map information corresponds to the location field and the flag information corresponds to different positions on the location field. The flag information corresponds to the corresponding identification information. The mobile electronic device includes a wireless communication module, a central processing module, and a display module. The wireless communication module, receiving the identification information transmitted from the wireless signal units, and having a wireless connection with the server device. The central processing module has a signal connection with the wireless communication module, and determines a distance between the mobile electronic device and the wireless signal unit transmitting the identification information, to obtain distance information. The display module can be driven by the central processing module, to show a display image. The mobile electronic device shows the position of the mobile electronic device on the location field, based on the identification information, the distance information, the flag information, and the map information.

In view of the above, the present invention provides a navigation method used in a navigation system. The navigation system includes a server device, a mobile electronic device, and a plurality of light emitting modules detachably secured in a plurality of lamps on a location field. The navigation method includes: the light emitting modules continuously transmitting the wireless signal with identification information; the mobile electronic device receiving the identification information, determining a plurality of distances respectively between the mobile electronic device and the light emitting modules transmitting the identification information, to store distance information corresponding to the distances; and the mobile electronic device determining a position of the mobile electronic device on the location field, based on the identification information, the distance information, the map information and flag information in the map information stored in the server device.

One benefit of the present invention is that: the feature of the replaceable light emitting module for transmitting wireless signal, and the navigation system and method using the light emitting module, can reduce the building and maintaining cost of each positioning reference point, by continuously transmitting the wireless signal with the identification information from the light emitting module (or the replaceable light emitting modules). Further, this technology can be effectively applied to various location fields needing the navigation service.

For better understanding of the features and technical of the present invention, please refer to the specification with reference to figures. The figures are for illustration purpose but not to limit the scope of the present invention.

### BRIEF DESCRIPTION OF THE DRAWINGS

FIG. 1 shows a schematic view of a location field including the navigation system according to a first embodiment of the present invention.

FIG. 2 shows a schematic block diagram of navigation system components according to the first embodiment of the present invention.

FIG. 3 shows a 3D schematic view of the light emitting module according to the first embodiment of the present invention.

FIG. 4 shows a schematic block diagram of internal components of the mobile electronic device according to the first embodiment of the present invention.

FIG. 5 shows a schematic flow chart of the navigation method according to a second embodiment of the present invention.

FIG. 6 shows a schematic flow chart of the navigation method according to a third embodiment of the present invention.

FIG. 7 shows a schematic flow chart of the navigation method according to a fourth embodiment of the present invention.

### DESCRIPTION OF THE PREFERRED EMBODIMENTS

The embodiments of the “replaceable light emitting module” disclosed by the present invention are described below with reference to the following embodiments. Those who skilled in the art can understand the advantages and benefits of the present invention of the technology disclosed in the specification. The present invention can be used with reference to various embodiments, modifications or the combinations of the embodiments, which are all within the scope of the invention. In addition, the figures of the present invention are for illustrative purpose and not to limit a scale or a size shown in figures. The following embodiments describe and explain the technical concept of the present invention, but are not to limit the scope of the present invention.

### First Embodiment

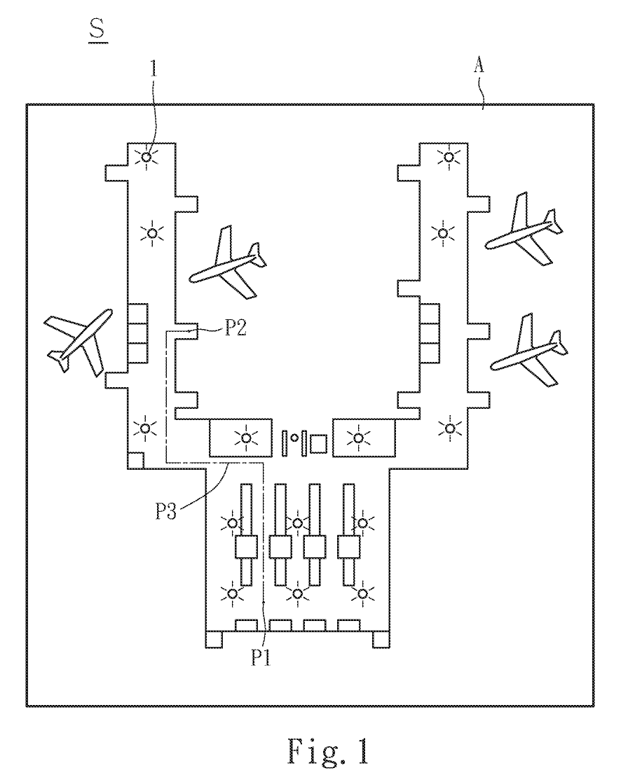

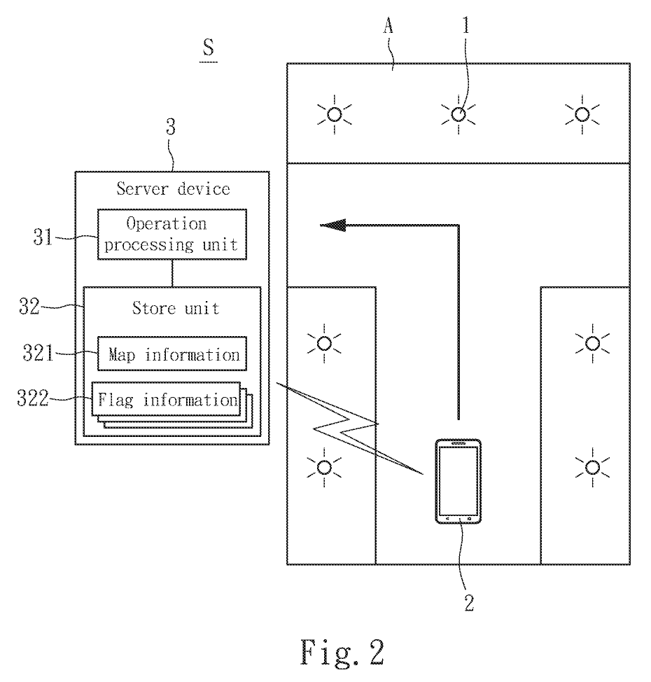

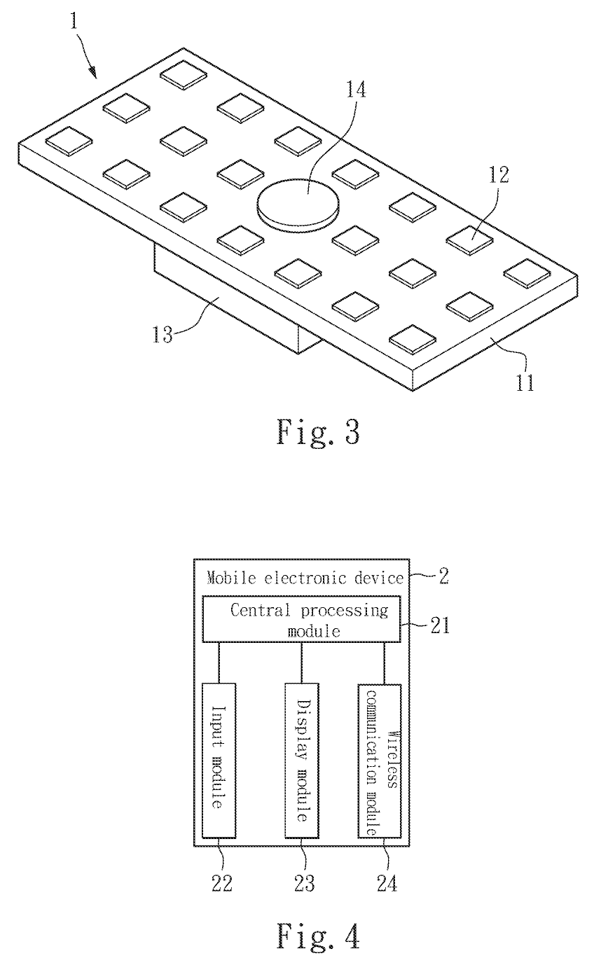

Please refer to FIGS. 1-4, wherein FIG. 1 shows a schematic view of a location field A having the navigation system S according to a first embodiment of the present invention. FIG. 2 shows a schematic block diagram of components of the navigation system S according to the first embodiment of the present invention. FIG. 3 shows a 3D schematic view of the light emitting module 1 according to the first embodiment of the present invention. FIG. 4 shows a schematic block diagram of internal components of the mobile electronic device 2 according to the first embodiment of the present invention.

First, with reference to FIG. 1, the present invention can be primarily utilized for indoor navigation. Usually, it needs to build a lighting device (ie, the light emitting module 1 of the present invention) on a location field A. For example, airport, stations, parking lots, department stores, and office buildings, etc., are feasible location fields A for the present invention. Importantly, the present invention can be not limited to a closed indoor room, but an open outdoor space, wherein the lighting devices are densely distributed, and there is a need for providing accurate navigation to use the technology of the present invention. This outdoor space can also be an option of the location field in the present invention.

One of the features of the present invention is that a plurality of replaceable light emitting modules 1 are disposed on the location field A, and the light emitting modules 1 continuously transmit wireless signals with identification information, thereon a positioning and navigation of the present invention are based. A user of the navigation system S and navigation method of the present invention, can obtain information of a navigation route P3 from a current position P1 to a target position P2, by the navigation system/navigation method of the present invention.

Please refer to FIGS. 1 and 2, wherein a simplified schematic block diagram of components of the navigation system S of the present invention is shown, to briefly describe a basic operation of the navigation system S. In the first embodiment of the present invention, the navigation system S is used on the location field A with a plurality of lamps (not drawn). The navigation system S includes a plurality of replaceable light emitting modules 1, a mobile electronic device 2, and a server device 3. The plurality of light-emitting modules 1 are respectively to be detachably disposed in the plurality of lamps on the location field A. The light-emitting module 1 continuously transmits the wireless signal with the identification information. The identification information within the wireless signal transmitted by one light module 1, is different from the identification information within the wireless signal from another light module 1.

When the user moves the mobile electronic device 2 (such as a mobile phone, a tablet computer, or a laptop computer) on one location field. The mobile electronic device 2 can receive the identification information from the plurality of the light emitting modules, to determine a plurality of distances between the light emitting modules 1 and the mobile electronic device 2. Thereby, a plurality of relative positions between the light emitting modules 1 and the mobile electronic device 2 can be obtained through the triangulation calculation.

For obtaining a physical position of the mobile electronic device 2, the map information 321 and the flag information 322 stored in the server device 3, are essential for calculating the relative positions between the light emitting modules 1 and the mobile electronic device 2. The map information corresponds to the location field A, and the flag information 322 corresponds to different positions in the map information 321. Each flag information 322 corresponds to specific corresponding identification information. Thus, through cross calculation between the relative positions, the physical position of the mobile electronic device 2 on the location field A can be obtained.

For further detail of the first embodiment of the present invention, with reference to FIG. 2, FIGS. 3 and 4 respectively show the light emitting modules 1 and the mobile electronic device 2, and the further technical detail in the specification content of the first embodiment of the present invention is described and explained as follows.

As shown in FIG. 3, each of the replaceable light emitting modules 1 for transmitting the wireless signal, includes a substrate 11, at least one light emitting unit 12, and a wireless signal unit 13. The substrate 11 is detachably secured in the lamp for supplying the power on the location field A (as shown in FIG. 2). The light emitting unit 12 is disposed on the substrate 11, and the wireless signal unit 13 is disposed on the substrate 11, and the wireless signal unit 13 continuously transmits the wireless signal with identification information.

Specifically, the substrate 11 may be directly embedded in the lamp on the location field A, or the entire light emitting module 1 in a modular design is detachably secured in the lamp, wherein the substrate is indirectly and detachably secured in the lamp.

The light emitting unit 12 can be an LED, an OLED or other light sources. In this embodiment, the light emitting unit 12 is the LED disposed on one side of the substrate 11. A body proximity sensor unit 14 is also disposed on the same side of the substrate 11. The body proximity sensor unit 14 has signal connection with the light emitting unit 12, to adjust a light intensity of the light from the light emitting unit 12. With the body proximity sensor unit 14, the light emitting module 1 may provide higher intensity light when someone approaches. The light intensity can be reduced when no one passes by. Thereby, the power can be effectively saved. The present invention is not limited to this embodiment, when the body proximity sensor unit 14 is not included, the positioning and navigation functions can be still achievable.

In this embodiment, the wireless signal unit 13 is disposed on a side of the substrate, opposite to the side of the substrate 11 disposing the light emitting unit 12, for avoiding occupying too much area of the substrate 11 by the wireless signal unit 13, and it can reserve enough area to dispose the light emitting unit 12. The wireless signal unit 13 can transmit signal by infrared, Bluetooth, ZigBee, ANT or Z-Wave. This embodiment is based on Bluetooth low energy (BLE) protocol, with a Bluetooth chip. The identification information transmitted in the wireless signal, is based on the information from the Bluetooth chip.

Please refer to FIG. 4, wherein the mobile electronic device 2 of this embodiment includes a central processing module 21, an input module 22, a display module 23, and a wireless communication module 24. The central processing module 21 has the signal connection with the input module 22 (buttons, touch screens, or etc.), the display module 23 (for example, the display screen integrated with the touch screen), and the wireless communication module 24. When the input module 22 receives an input operation, the central processing module 21 can receive the input signal from the input module 22 signals. The central processing module 21 can also transmit signals to the display module 23, to drive the display module 23 to show the display image. Besides, the central processing module 21 can also control the wireless communication module 24 to transmit/receive the wireless signal.

The wireless communication module 24 can use different communication protocols and/or wireless signal transmission modes, to communicate with the wireless signal unit 13 of the light emitting module 1. The wireless communication module 24 also provides communication services with Wi-Fi, WiFly, GPRS, GSM, WCDMA and LTE, to have wireless connection with the server device 3. In general, the wireless communication module 24 receives the identification information from the plurality of wireless signal units 13, and has wireless connection with the server device 3. The central processing module 21 generates the distance information, by determining the distance between the wireless signal unit 13 and the mobile electronic device 2 which transmits the identification information. In addition, the central processing module 21 can transmit/receive information by controlling the wireless communication module 24, to make the mobile electronic device 2 and the server device 3 to transmit messages between each other (for example, receiving map information 321 from the server device 3).

Next, please refer to FIG. 2 for the detail of the first embodiment of the present invention, with reference to the specifications related to FIGS. 3 and 4. In the first embodiment, when the user wishes to use the navigation system S/navigation method of the present invention, the user can first download and install the relevant application software in the mobile electronic device 2 (such as a smart phone). Thus, when activating the software, the communication connection between the wireless communication module 24 and the wireless signal unit 13 is built. The plurality of light emitting modules 1 disposed on the location field A, continuously transmit the wireless signals having identification information by the wireless signal unit 13. Therefore, the mobile electronic device 2 can receive the wireless signal in the signal transmission range of the light emitting module 1.

The wireless signals transmitted by each of the light emitting module 1 have different contents of the identification information, and the mobile electronic device can separately record the received identification information. The received signal strength of the wireless signal can also be used to determine the distance between t the mobile electronic device 2 and the light emitting module 1 transmitting the wireless signal. This distance can be recorded as the distance information.

Therefore, the mobile electronic device 2 can generate the position information of the mobile electronic device 2, based on the identification information, the distance information, the flag information 322 and the map information 321 stored in the server device 3. With the position information, the position of the mobile electronic device 2 on the location field A, can be shown on the display module 23 of the mobile electronic device 2.

The above explains the essential positioning process of the present invention. A further technical detail for the server device 3, is further explained by the following second and third embodiments. The navigation method of the present invention is also explained therein.

### Second Embodiment

Please also refer to the schematic architecture shown in FIG. 2 for understanding the mark naming relation between the components, with reference to the specification details in FIGS. 3 and 4. In the second embodiment of the present invention, after the mobile electronic device 2 receives the identification information and the distance information from each of the light emitting modules 1, the mobile electronic device 2 transmits a positioning signal to the server device 3, according to the identification information and the distance information. In this embodiment, the server device 3 includes an operation processing unit 31 and a storage unit 32 for storing the map information 321 and the flag information 322. The operation processing unit 31 can read and write the information in the store unit 32, so that operation processing unit 31 can read the map information 321 and the flag information 322.

In the first embodiment, the mobile electronic device 2 can obtain the position information of the mobile electronic device 2, based on the identification information, the distance information, and the flag stored in the server device. More specifically, in the second embodiment, the positioning signal is transmitted to the server device 3 from the mobile electronic device 2, and the server device 3 generates the positioning information back to the mobile electronic device 2. The present invention is not limited thereto, and further implementation is detailed in the third embodiment of the present invention.

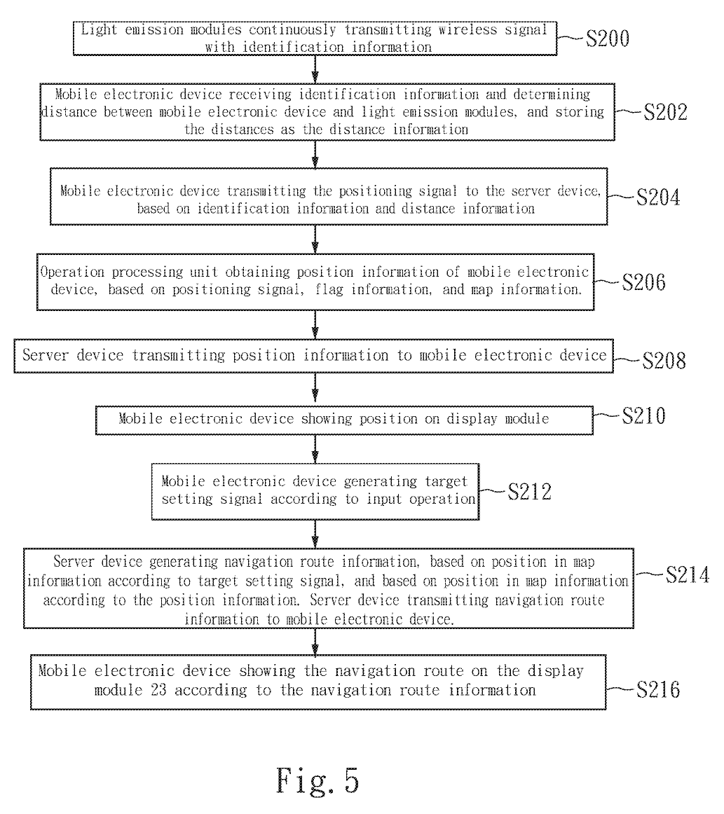

The positioning and navigation according to the second embodiment of the present invention, are further detailed as follows. Please refer to the schematic flowchart in FIG. 5, with reference to the component marks in FIGS. 2-4. The second embodiment of the present invention primarily includes the following steps:

S200: the plurality of light emitting modules 1 continuously transmitting the wireless signal with identification information;

S202: the mobile electronic device 2 receiving the identification information and determining the distance between the mobile electronic device 2 and the light emitting modules 1 transmitting the identification information, and storing the distances as the distance information;

S204: the mobile electronic device 2 transmitting the positioning signal to the server device 3, based on the identification information and the distance information;

S206: the operation processing unit 31 of the server device 3 obtaining the position information of the mobile electronic device, based on the positioning signal, the flag information 322, and the map information 321;

S208: the server device 3 transmitting the position information to the mobile electronic device 2;

S210: the mobile electronic device 2 showing the position on the display module 23;

S212: the mobile electronic device 2 generating a target setting signal according to the input operation, and transmitting the target setting signal to the server device 3;

S214: the server device 3 generating a navigation route information, based on the position in the map information 321 according to the target setting signal, and based on the position in the map information 321 according to the position information. The server device 3 transmitting the navigation route information to the mobile electronic device 2; and

S216: the mobile electronic device 2 showing the navigation route on the display module 23 according to the navigation route information.

Specifically, in the second embodiment of the present invention, the navigation method of the present invention can be used in the navigation system S. The navigation system S includes the server device 3, the mobile electronic device 2 and the plurality of light emitting modules 1 detachably secured in the lamps on the location field A. When the user makes the mobile electronic device 2 to move into the location field A, the mobile electronic device 2 receives the wireless signal continuously transmitted from the light emitting modules 1. The mobile electronic device 2 determines the light emitting modules 1 based on the received wireless signals, and records the distance information between the mobile electronic device 2 and the light emitting modules 1 (steps S200 and step S202). Next, the mobile electronic device 2 transmits the positioning signal to the server device 3, based on the identification information in the wireless signal and the generated distance information (step S204).

After the server device 3 receives the positioning signal, the operation processing unit 31 of the server device 3 analyzes the identification information in the positioning signal, and then finds the flag information 322 corresponding to the identification information, to obtain the position information of the mobile electronic device 2 in the map information through the triangulation calculation (step S206) according to the three sets of identification information and the corresponding distance information. The mobile electronic device 2 is located at the location information corresponding to the map information 321 (step S206). After the server device 3 obtains the position information of the mobile electronic device 2 based on the positioning signal, the flag information 322, and the map information 321, the position information is transmitted back to the mobile electronic device 2 (step S208).

When the mobile electronic device 2 receives the position information, the central processing module 21 drives the display module 23 to show the position of the mobile electronic device 2 on the location field A, on the display module 23 (step S210). Thus, the user can observe the current position on the display module 23.

During implementation, the map information 321 that is originally stored in the server device 3, can be pre-downloaded into the mobile electronic device 2. It is also possible to receive the wireless signal from any light emitting module 1 by the mobile electronic device 2, and send the positioning signal to the server device 3. The server device 3 transmits the map information 321 corresponding to the flag information 322 back to the mobile electronic device 2. The present invention does not restrict the timing for when the mobile electronic device 2 stores the map information 321.

The navigation method of the second embodiment of the present invention is explained hereon. When the user obtains the current position P1 (as shown in FIG. 1, the position of the mobile electronic device 2 on the location field A), the used can further obtain the navigation route P3 to the target position P2 (shown in FIG. 1) provided by the navigation system S/navigation method of the present invention. As shown in FIG. 1, the user can set the target by the input module 22 of the mobile electronic device 2 (for example, through the touch screen, choose the boarding gate). In this moment, the mobile electronic device 2 generates a target setting signal according to the above input operations, and transmits it to the server device 3 (step S212).

In this embodiment, after the server device 3 receives the target setting signal, the server device 3 generates the navigation route information based on the position in the map information corresponding to the target setting signal, and the corresponding position in the map information 321 corresponding to the position. The navigation route information is transmitted to the mobile electronic device 2, such that the central processing module 21 of the mobile electronic device 2 can drive the display module 23 to show the navigation route, based on the navigation route information, and the display module 23 displays the navigation route (steps S214 and S216). It is particularly noted that the present invention is not restricted hereto. In other embodiments of the present invention, the related operation may also be performed in the mobile electronic device 2, without transmitting the information from the mobile electronic device to the server device 3 for the corresponding operation, and there is no need to transmit the operation result back to the mobile electronic device 2.

### Third Embodiment

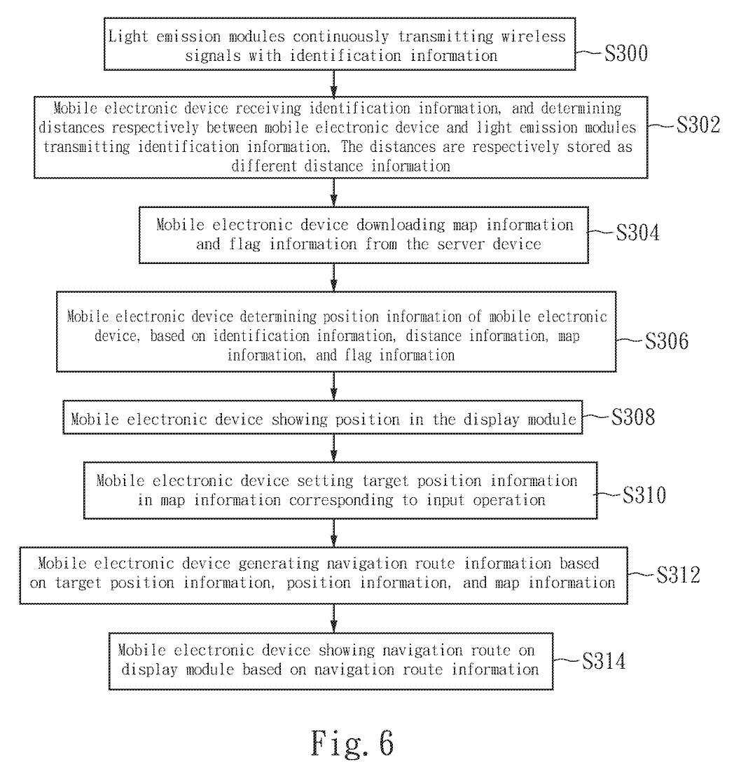

Hereinafter, the navigation method according to the third embodiment of the present invention is characterized with reference to the component marks in FIGS. 2-4 and the flowchart in FIG. 6. FIG. 6 shows the schematic flowchart of the navigation method according to the third embodiment. The navigation method primarily includes the following steps:

S300: the plurality of light emitting modules 1 continuously transmitting the wireless signals with identification information;

S302: the mobile electronic device 2 receiving the identification information, and determining the distances respectively between the mobile electronic device 2 and the light emitting modules 1 transmitting the identification information. The distances are respectively stored as different distance information;

S304: the mobile electronic device 2 downloading the map information 321 and the flag information 322 from the server device 3;

S306: the mobile electronic device 2 determining the position information of the mobile electronic device 2, based on the identification information, the distance information, the map information 321, and the flag information 322;

S308: the mobile electronic device 2 showing the position in the display module 23;

S310: the mobile electronic device 2 setting target position information in the map information 321 corresponding to the input operation;

S312: the mobile electronic device 2 generating the navigation route information based on the target position information, the position information, and the map information;

S314: the mobile electronic device 2 showing the navigation route on the display module 23 based on the navigation route information.

Specifically, in the second embodiment of the present invention, the navigation method of the present invention can be used in the navigation system S, and the navigation system S includes the server device 3, the mobile electronic device 2 and the plurality of light emitting modules 1 detachably secured in the plurality of lamps on the location field A. In the steps S300 and S302, the third embodiment is not significantly different from the second embodiment. In the second embodiment, most of the calculation operations are done by the operation processing unit 31 of the server device 3, but most of the calculation operations in the third embodiment are done in the central processing module 21 of the mobile electronic device 2.

In the third embodiment of the present invention, the calculation operation is primarily done in the central processing module 21, so that the mobile electronic device must download the map information 321 and the flag information 322 from the server device 3 (step S304). The step of downloading the map information 321 and/or the flag information 322 from the server device 3 to the mobile electronic device 2 can be performed at different timing points. The present invention is not intended to limit the time sequence for storing the map information 321 in the mobile electronic device 2. The mobile electronic device 2 obtains the identification information, and the distance information obtained from the wireless signal and the distance information from the light emitting modules 1. The mobile electronic device 2 obtains the map information 321 and the flag information 322 from the server device 3. The central processing module 21 can obtain the position information of the mobile electronic device 2 in the map information 321, based on the identification information, the distance information, the map information 21, and different flag information 322 (step S306). The position P1 (FIG. 1) of the mobile electronic device 2 on the location field A, can be shown on the display module 23 based on the position information (step S308).

The above is the positioning method according to the third embodiment of the present invention, and the navigation method in the third embodiment is characterized below. As described above, after the user obtains the current position P1, when the user wishes to further use the navigation system S/navigation method to obtain the navigation route P3 to the target position P2 (as shown in FIG. 1), the user can set the target (for example, by inputting a keyword of a specific place on a keyboard) by the input module 22 of the mobile electronic device 2. The mobile electronic device 2 can set the target position information in the map information 321 according to the input operation (step S310) (That is, making a mark in the map information 321). Next, the central processing module 21 of the mobile electronic device 2 can generate the navigation route information, based on the target position information (marked position), the position information, and the map information 321 (step S312). Besides, the central processing module 21 will drive the display module 23 to show the navigation route P3 according to the navigation route information. The navigation route P3 is displayed (step S314) (many prior applications for the route generation in the field, which are not the technical focus of the present invention, so that it is not detailed here. Those skilled in the art can make use of the present invention together with the techniques known in the art. The practical application of the present invention is not limited under the detail of generating the navigation route is not detailed).

### Fourth Embodiment

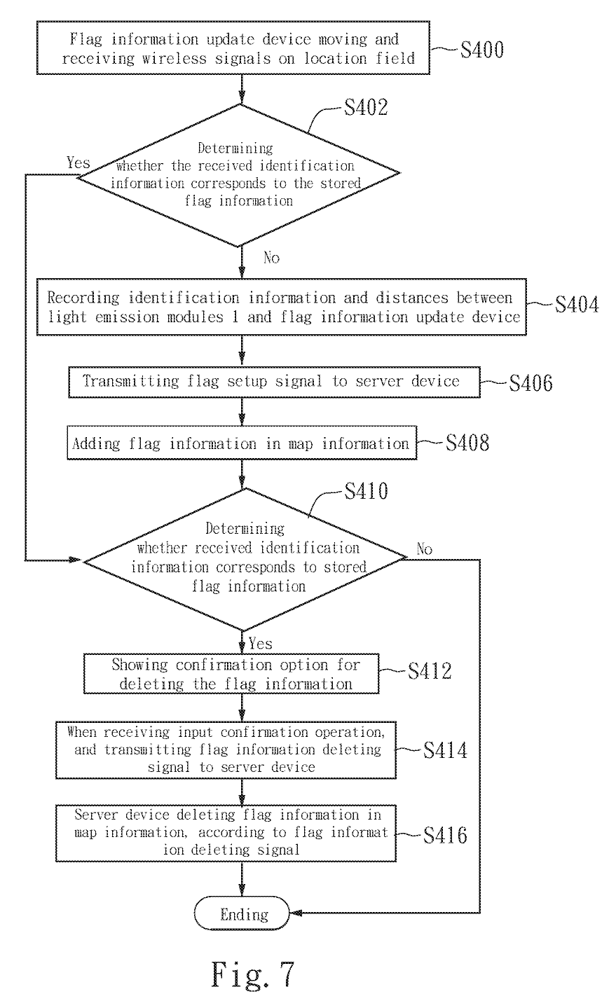

The above-mentioned embodiments are primarily focused on the back-end application of the navigation system S and the navigation method of the present invention. However, one of the technical benefits of the present invention is greatly reducing the cost of building and maintaining the positioning reference points (for example, the setting points of each light emitting modules 1) of the navigation system S, with the replaceable light emitting module 1 and the light emitting modules 1 continuously transmitting the wireless signals with the identification information. Thus, the technique of the present invention can be easily used in any location field A having navigation needs. In order to further highlight the benefits of the present invention in building and maintaining the components referred to the component marks in FIGS. 2-4 with the flowchart in FIG. 7, the fourth embodiment of the present invention is described in detail of the steps of building and maintaining the flag information, with reference to the flowchart in FIG. 7. The fourth embodiment of the present invention primarily includes the following steps:

S400: A flag information update device moving and receiving the wireless signals on the location field A;

S402: the flag information update device determining whether the received identification information corresponds to the stored flag information. If no, proceeding to step S406; or, if yes, proceeding to step S410;

S404: the flag information update device recording the identification information and the distances between the light emitting modules 1 and the flag information update device;

S406: the flag information update device transmitting the flag setup signal to the server device 3;

S408: the server device 3 adding the flag information 322 in the map information 321;

S410: determining whether the received identification information corresponds to the stored flag information 322. If no, ending the method; or, if yes, proceeding to step S412;

S412: the flag information update device showing confirmation option for deleting the flag information 322;

S414: when the flag information update device receiving input confirmation operation, transmitting a flag information deleting signal to the server device 3;

S416: the server device 3 deleting the flag information 322 in the map information 321, according to the flag information deleting signal.

Specifically, in the fourth embodiment of the present invention, when the navigation system S/navigation service provider (hereinafter, the dealer) builds the light emitting modules 1 in the navigation system S, or maintains the light emitting modules 1 in the navigation system S, the dealer must re-build or redefine the map information 321 corresponding to the location field A, and the position of the flag information 322 in the map information 321. Therefore, the navigation system S including the navigation method of the present invention further includes a flag information update device. The flag information update device stores the same map information 321 and the same flag information as stored in the server device 3. The dealer can move the flag information update device with the wireless communication function on the location field A (step S400). This flag information update device may be a special device, or the same device as the mobile electronic device 2 in further embodiments. For example, the flag information update device may be a mobile phone with a corresponding software installed therein. Or, the flag information update device may be a mobile phone with the same software as installed in other mobile phones, and further includes an account with permission to update the information in the server device 3. The figures in the present invention, have not any component mark especially for the flag information update device, which can be referred to the mobile electronic device 2.

In the fourth embodiment of the present invention, when the dealer makes the flag information update device to move on the location field A for receiving the wireless signal, the flag information update device can receive a number of the wireless signals from the light emitting modules 1. The flag information update device can analyze and determine the identification information in the wireless signal. Next, the flag information update device determines whether the received identification information corresponds to the stored flag information or not. The determining process may includes: transmitting the received identification information by the flag information update device to the server device 3 for determining purpose; or the flag information update device downloading the map information 321 and the flag information 322 from the server device 3 in advance, and performing the determining process by the flag information update device. The details can be referred to the second and third embodiments, and are not described redundantly here.

When the flag information update device determining that the map information 321 does not have the flag information 322 corresponding to the identification information (the identification information cannot correspond to any stored flag information 322), the light emitting module 1 that transmits the identification information may be not build on the location field A in advance. Therefore, the corresponding flag information 322 in the map information 321 must be built in advance. The flag information update device records the identification information and the distance between the light emitting module 1 and the flag information update device. The flag information update device transmits the flag setup signal to the server device 3 (steps S406 and S408). When the server device 3 receives the flag setup signal, the server device 3 will generate new flag information 322 in the map information 321 based on the flag setup signal.

In another possible situation, when the dealer makes the flag information update device to move on the location field A, it is to approach to the position for possibly receiving the specific identification information (according to the flag information 322 in the map information 321). When receiving no corresponding identification information, the built light emitting module 1 may have removed or malfunction. The flag information update device can also determine whether the identification information corresponding to the stored flag information can be received or not (step S410). When the corresponding identification information is not received, more step is required: the flag information update device will show the confirmation option for deleting the flag information 322. (step S412). This confirmation option has two benefits: first, the dealer can easily replace the built light emitting module 1 with a new light emitting module 1, to update the flag information 322 in the map information 321 by the flag information update device; secondly, when the dealer makes the flag information update device to move on the location field A, the unexpected failure can be found or the light emitting module 1 with problems can be repaired. When the problems can be repaired by simple maintenance, the flag information 322 from the light emitting module 1 with problems can be cancelled in current operation, without deleting this flag information 322 (available in the next operation after repairing the light emitting module 1).

In the previous embodiment, when the dealer confirms deleting the stored flag information on the input confirmation operation (for example, confirmation by clicking), the flag information update device transmits the flag information deleting signal to the server device 3 (step S414), so that the server device 3 deletes the stored flag information 322 in the map information 321 of the server device 3 according to the flag information deleting signal (step S416). In this way, when some light emitting module 1 does not exist on the location field A, the corresponding flag information 322 can be conveniently deleted through the foregoing steps, to update the navigation system S.

### Benefits of the Embodiments

The benefits of the present invention are based on: the replaceable light emitting module for transmitting wireless signal (or the navigation system/method using the light emitting module provided by the present invention), continuously transmits the wireless signal with the identification information by the replaceable light emitting module 1 or the light emitting module 1, and thereby the cost of building or maintaining the positioning reference points of the navigation system S can be greatly reduced, and the replaceable light emitting module for transmitting wireless signal (or the navigation system/method using the light emitting module) is convenient for using on various location fields A with navigation requirements.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. Besides, an embodiment or a claim of the present invention does not need to attain or include all the objectives, advantages or features described in the above. The abstract and the title are provided for assisting searches and not to be read as limitations to the scope of the present invention. It is not limited to each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. All such modifications and variations should fall in the scope of the present invention.

What is claimed is:

1. A replaceable light emitting module for transmitting wireless signal, comprising:
a substrate;
at least one light emitting unit, disposed on the substrate; and
a wireless signal unit, disposed on the substrate, wherein the wireless signal unit is configured to continuously transmit the wireless signal with identification information;
wherein, the substrate is detachably secured in a lamp for providing power.

2. The replaceable light emitting module for transmitting wireless signal according to claim 1, further comprising: a body proximity sensor unit, disposed on the substrate, the body proximity sensor unit having a signal connection with the light emitting unit, for adjusting a light intensity emitted from the light emitting unit.

3. The replaceable light emitting module for transmitting wireless signal of claim 2, wherein the body proximity sensor unit and the light emitting unit are disposed on the same side of the substrate, and the wireless signal unit is disposed on aside of the substrate, opposite to aside of the substrate disposing the light emitting unit.

4. A navigation system, used on a location field having a plurality of lamps, the navigation system comprising:
a plurality of replaceable light emitting modules, respectively disposed in the lamps on the location field, wherein each of the replaceable light emitting module comprising:
a substrate, detachably secured in the lamp;
at least one light emitting unit, disposed on the substrate; and
a wireless signal unit, disposed on the substrate, and configured to continuously transmit the wireless signal with identification information;
a server device, storing map information and flag information, wherein the map information corresponds to the location field and the flag information corresponds to different positions in the flag information, and the flag information corresponds to the corresponding identification information; and
a mobile electronic device, comprising:
a wireless communication module, receiving the identification information transmitted from the wireless signal units, and having a wireless connection with the server device;
a central processing module, having a signal connection with the wireless communication module, and determining a distance between the mobile electronic device and the wireless signal unit transmitting the identification information, to obtain distance information;
a display module, driven by the central processing module, to show a display image;
wherein, the mobile electronic device shows the position of the mobile electronic device on the location field, based on the identification information, the distance information, the flag information, and the map information.

5. The navigation system of claim 4, wherein the server device receives a target setting signal from the mobile electronic device, and the server device comprises an operation processing unit;
wherein the operation processing unit transmits navigation route information to the mobile electronic device, based on the identification information, the distance information, the flag information, the map information, and the target setting signal; and
wherein the mobile electronic device shows a navigation route on the display module according to the received navigation route information.

6. The navigation system of claim 4, wherein the mobile electronic device comprises an input module, which receives an input operation to generate a target setting signal;
wherein the mobile electronic device receives the flag information and the map information from the server device, and the central processing module transmits navigation route information to drive the display module to show a navigation route, based on the identification information, the distance information, the flag information, the map information, and the target setting signal.

7. A navigation method, used in a navigation system which comprises a server device, a mobile electronic device, and a plurality of light emitting module detachably secured in a plurality of lamps on a location field, wherein the navigation method comprises:
the light emitting modules continuously transmitting the wireless signal with identification information;
the mobile electronic device receiving the identification information, determining a plurality of distances respectively between the mobile electronic device and the light emitting modules transmitting the identification information, to accordingly store the distances as distance information; and
the mobile electronic device determining a position of the mobile electronic device on the location field, based on the identification information, the distance information, map information and flag information stored in the server device.

8. The navigation method of claim 7, further comprising:
the mobile electronic device receiving the map information from the server device;
the mobile electronic device transmitting a positioning signal to the server device, based on the identification information and the distance information;
an operation processing unit of the server device, obtaining position information, based on the positioning signal, the flag information, and the map information;
the mobile electronic device generating a target setting signal based on an input operation, and transmitting the target setting signal to the server device;
the server device generating navigation route information based on a position in the map information corresponding to the target setting signal, and a position in the map information corresponding to the position information, to transmit the navigation route information to the mobile electronic device; and
the mobile electronic device driving the display module to show a navigation route, based on the navigation route information.

9. The navigation method of claim 7, further comprising:
the mobile electronic device receiving the map information and the flag information from the server device;
a central processing module in the mobile electronic device, obtaining position information of the mobile electronic device, based on the positioning signal, the flag information, and the map information;
the mobile electronic device generating a target setting signal based on an input operation, and generating navigation route information based on a position in the map information corresponding to the target setting signal, and a position in the map information corresponding to the position information;
the mobile electronic device driving the display module to show a navigation route based on the navigation route information.

10. The navigation method of claim 7, wherein the navigation system using the navigation method, further comprises a flag information update device, which stores the same map information and the same flag information as stored in the server device, wherein the navigation method further comprises:
the flag information update device moving on the location field and receiving a plurality of wireless signal from the light emitting modules;
when the identification information received by the flag information update device, does not correspond to any of the stored flag information, recording the identification information, and recording a distance between the flag information update device and the light emitting module transmitting the identification information, and storing the distance information, and transmitting a flag setup signal to the server device based on the identification information and the distance information, to make the server device generate new flag information and the server device storing the new flag information in the map information; and
when the flag information update device does not receive the identification information corresponding to the stored flag information, showing a confirmation option for deleting the stored flag information, wherein when receiving a deleting confirmation, transmitting a flag information deleting signal to the server device, to make the server device delete the stored the flag information in the map information based on the flag information deleting signal.
